(19) United States
(12) Patent Application Publication
(10) Pub. No.: US 2012/0023166 A1
(43) Pub. Date: Jan. 26, 2012

(54) AUGMENTED REALITY APPARATUS AND METHOD

(75) Inventors: Young-Kyoung KIM, Seoul (KR); Jin-Woo PARK, Seoul (KR); Woon-Yeol LEE, Gwacheon-si (KR)

(73) Assignee: PANTECH CO., LTD., Seoul (KR)

(21) Appl. No.: 13/028,705

(22) Filed: Feb. 16, 2011

(30) Foreign Application Priority Data
Jul. 26, 2010 (KR) 10-2010-0072028

(51) Int. Cl. G06F 15/16

(52) U.S. Cl. 709/204

(57) ABSTRACT

A terminal, server, system, and method for providing private tag information by the terminal accessible to the server through a wired/wireless communication network are provided. The method includes recognizing an object, detecting private tag information related to the recognized object, the private tag information including a sharing range, and outputting the detected private tag information.

### CROSS-REFERENCE TO RELATED APPLICATION

This application claims priority from and the benefit under 35 U.S.C. §119(a) of Korean Patent Application No. 10-2010-0072028, filed on Jul. 26, 2010, the disclosure of which is incorporated by reference in its entirety for all purposes.

### BACKGROUND

1. Field

The following description relates to an augmented reality terminal, server, system, and method.

2. Discussion of the Background

Augmented reality (AR) is a computer graphic scheme allowing a virtual object or information to be viewed as if the virtual object or information were in a real world environment is by combining the virtual object or information with an image of the real world environment.

Unlike conventional virtual reality, which has only a virtual space and a virtual object, AR further provides additional information that is not easily obtained in the real world by adding a virtual object to the real world. That is, unlike virtual reality, which is applicable only to limited fields, such as computer games, AR is applicable to various types of real world environments and has been spotlighted as a next generation display technology desirable in a ubiquitous environment.

For example, when a tourist on a street in London points a camera of a mobile phone having various types of functions, such as GPS, in a predetermined direction, information about a pub on the street or information regarding a sale in a shop is overlaid or overlapped with an image of the actual street and displayed to the tourist.

In one example of a conventional technique for providing an AR service, a user registers various types of information about an object existing in real world on a radio frequency identification (RFID), so the information is shared with other users. However, tag information registered through such a conventional technique is open to all users of other services regardless of the intention of a registrant.

Accordingly, in an AR system using the above technology, private tag information registered by an individual user is open to other users as public tag information, so that privacy or private information of a user is not protected.

In addition, the same AR information is provided to all users regardless of tendencies of each user, thus causing difficulty in satisfying various demands of the users.

### SUMMARY

Exemplary embodiments of the present invention provide a terminal, server, system, and method for providing private information capable of protecting private information about a user by storing the private information in the form of a private tag.

Exemplary embodiments of the present invention provide a terminal, server, system, and method for providing private information capable of satisfying various tendencies and demands of users.

Exemplary embodiments of the present invention provide a terminal, server, system, and method for providing private information capable of allowing private information to be used only by a specific group.

Exemplary embodiments of the present invention provide a terminal, server, system, and method for providing private information capable of improving the security of private information by limiting the right to use the private information to a specific group.

Exemplary embodiments of the present invention provide that a user can protect his/her own private information about an object by storing the private information as a private tag.

Exemplary embodiments of the present invention provide that a user can satisfy various demands and tendencies by registering specified information according to his/her desire.

Exemplary embodiments of the present invention provide that private tag information is displayed to a specific group, i.e., a right to view the private tag information is granted to a specific user or a specific group, thereby encouraging participation in a social network, such as a blog or an internet community.

Exemplary embodiments of the present invention provide that, by the above group sharing, if the number of service users is substantially increased, private tag information is provided from a reliable group, so that spam tag information, opened as public tag information, may be blocked.

Additional features of the invention will be set forth in the description which follows, and in part will be apparent from the description, or may be learned by practice of the invention.

An exemplary embodiment provides a method for providing a private tag by a terminal accessible to a server, the method including: recognizing an object by the terminal; detecting private tag information corresponding to the recognized object, the private tag information including a sharing range; and outputting the detected private tag information in the terminal.

An exemplary embodiment provides a method of providing private tag information by a terminal accessible to a server, the method including: receiving, in the terminal, user information related to an object; and storing the received user information as private tag information related to the object, the private tag information including a sharing range.

An exemplary embodiment provides a method for providing private tag information by a server that is accessible to two or more terminals, the method including: receiving private tag information representing user information, which is related to an object, and information about a sharing range of the private tag information from a first terminal; and transferring the received private tag information to a second terminal within the sharing range of the received private tag information.

An exemplary embodiment provides a terminal to provide private tag information, the terminal including: an object recognition unit to output object recognition information indicating that an object is recognized; an output unit to output private tag information; a storage unit to store one or more pieces of private tag information; and a control unit to detect private tag information, which corresponds to the object recognition information output from the object recognition unit and includes a sharing range, from the storage unit, and to output the detected private tag information through the output unit.

An exemplary embodiment provides a server to provide private tag information, the server including: a communication unit to process information, which is transmitted to and/or received from one or more terminals, a memory unit to temporarily store private tag information; and a control unit to receive, from a first terminal through the communication unit, private tag information including user information, which is related to an object, and sharing range information about a sharing range of the private tag information, to store the received private tag information in the memory unit, and to transfer the received private tag information to a second terminal within the sharing range of the received private tag information.

An exemplary embodiment provides a method for providing private tag information by a terminal accessible to a server, the method including: recognizing an object; transferring object recognition information about the recognized object to the server; receiving private tag information including a sharing range from the server; and outputting the received private tag information.

An exemplary embodiment provides a method for providing private tag information by a server which is accessible to one or more terminals, the method including: storing the private tag information, the private tag information being received from the one or more terminals and including a sharing range and information related to an object; receiving object recognition information from a first terminal of the one or more terminals; detecting private tag information corresponding to the object recognition information; and transferring the detected private tag information to the first terminal if the first terminal is within the sharing range of the detected private tag information.

An exemplary embodiment provides a method for providing private tag information by a terminal accessible to a server, the method including: receiving user information related to an object; and transmitting to the server the received user information and requesting for registering of the received user information as private tag information, the private tag information being related to the object and including a sharing range.

An exemplary embodiment provides a method for providing private tag information by a server accessible to one or more terminals, the method including: receiving private tag information from the one or more terminals; and setting a sharing range of the received private tag information and registering the received private tag information according to the sharing range.

An exemplary embodiment provides a terminal to provide private tag information, the terminal including: an object recognition unit to recognize an object and to output object recognition information about the recognized object; an output unit to output tag information; a communication unit to process information transmitted to and/or received from a server; and a control unit to transfer the object recognition information output from the object recognition unit to the server through the communication unit, to receive private tag information including a sharing range from the server, and to output the received private tag information through the output unit.

An exemplary embodiment provides a server to provide private tag information, the server including: a communication unit to access one or more terminals to process information transmitted to and/or received from the one or more terminals; a storage unit to store is one or more pieces of tag information; a control unit to, in response to receipt of object recognition information from a first terminal of the one or more terminals, detect private tag information corresponding to the object recognition information among the one or more pieces of tag information in the storage unit, and to transfer the detected private tag information to the first terminal if the first terminal is within a sharing range of the detected private tag information.

It is to be understood that both the foregoing general description and the following detailed description are exemplary and explanatory and are intended to provide further explanation of the invention as claimed. Other features will be apparent from the following detailed description, drawings, and claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates private tag information according to an exemplary embodiment.

FIG. 2 illustrates private tag information according to an exemplary embodiment.

FIG. 3 is a block diagram illustrating an AR system according to an exemplary embodiment.

FIG. 4 illustrates a method of providing private tag information according to an exemplary embodiment;

FIG. 5 illustrates a method of providing private tag information according to an exemplary embodiment.

FIG. 6 is a block diagram illustrating an AR system according to an exemplary embodiment.

FIG. 7 illustrates a method of providing private tag information according to an exemplary embodiment;

FIG. 8 illustrates a method according to an exemplary embodiment.

Like elements, features, and structures are denoted by like reference numerals throughout the drawings and the detailed description, and the size and proportions of some elements may be exaggerated in the drawings for clarity and convenience.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art.

According to a method of providing private tag information in an augmented reality (AR) system according to aspects of the present invention, user input information related to an object existing in the real world is registered, edited, and/or deleted as private tag information having limited sharing, and private tag information related to an object, which is recognized by a user, is provided based on object recognition. In addition, a sharing range of private tag information is set such that private tag information is provided to a user terminal belonging to or being within the sharing range.

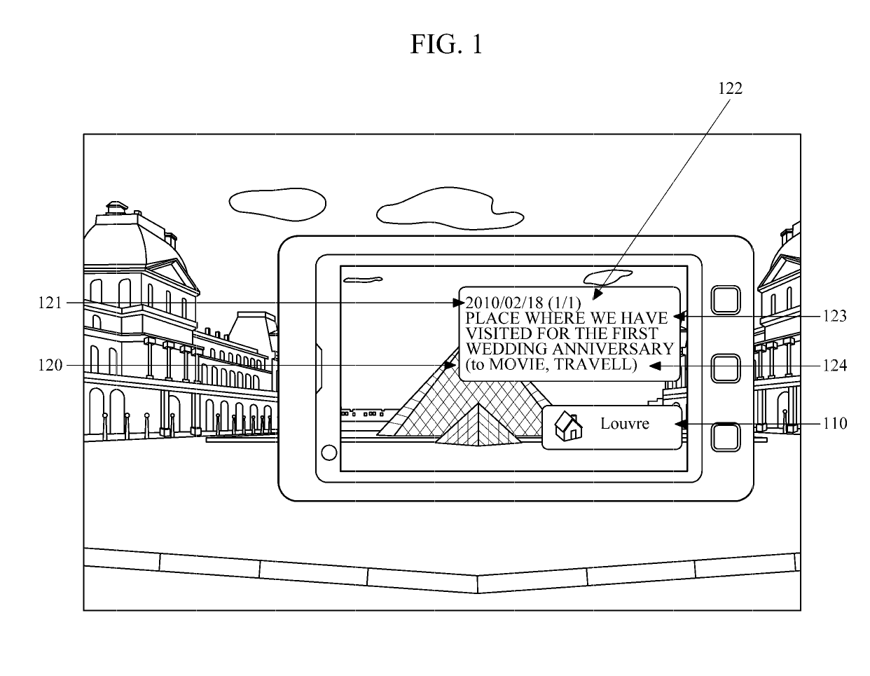

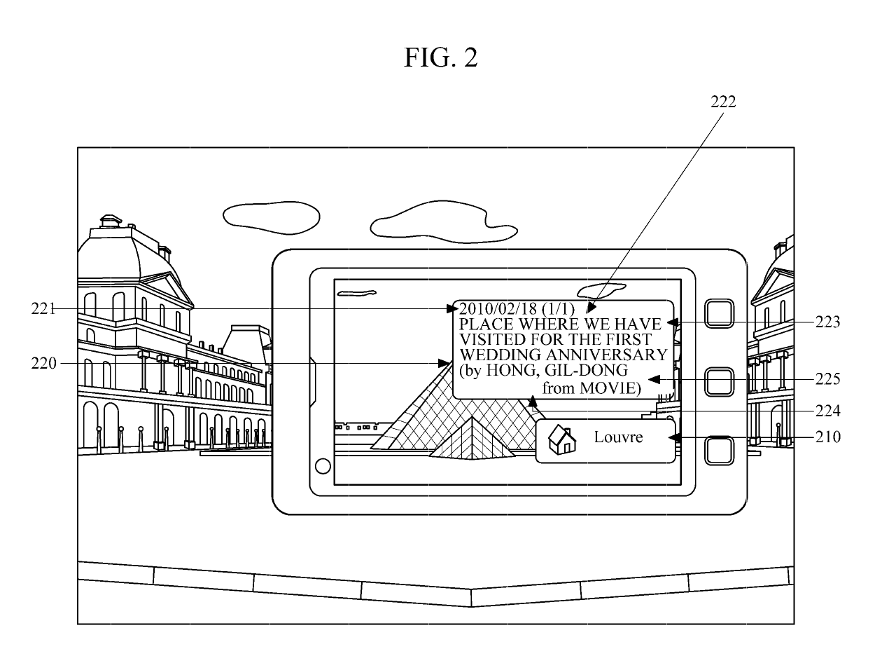

Hereinafter, examples will be described in detail with reference to accompanying drawings. Examples of a process of providing private tag information will be described with reference to FIG. 1 and FIG. 2.

FIG. 1 illustrates private tag information according to an exemplary embodiment. Further, FIG. 1 illustrates a screen of a terminal if a user A generates private tag information. If the user A visits the Louvre Museum and directs a camera at the Louvre Museum, the terminal outputs a public tag 110 written with the text “Louvre” in the form of an icon. In order to keep a record of the visit to the Louvre Museum for the first wedding anniversary trip of the user A, the user generates a private tag 120. The private tag 120 may include date information 121 regarding the date on which a private tag 120 is generated, number information 122 regarding the number of opened private tags, content information 123 regarding the content input by a user, and group information 124 regarding groups to which the private tag is opened, and the like. As shown in FIG. 1, the public tag 110 and the private tag 120 are displayed on the screen of the terminal.

FIG. 2 illustrates private tag information according to an exemplary embodiment. Further, FIG. 2 illustrates a screen of a terminal displaying private tag information that is registered by a user A and provided to a user B. As shown in FIG. 2, if a user B on a trip to the Louvre Museum directs the camera of a terminal at the Louvre Museum, the terminal outputs a public tag 210 in the form of an icon written with the text “Louvre”. Since the user B is a member of a group “Movie,” even if the user B has not written any private tag, the terminal of the user B displays a private tag 220 generated by the user A in addition to the public tag 210.

In this case, the private tag 220 may include date information 221 regarding the date when the private tag 220 is generated, number information 222 regarding the number of opened private tags, content information 223 regarding the content input by a user, registrant information 224, regarding a registrant, for example, the name of a registrant, Hong, Gil-Dong, and group information 225 regarding a group to which the registrant belongs, for example “Movie.”

In addition, an AR apparatus may be applied to any apparatus capable of recognizing an object, registering private tag information corresponding to the recognized object, and displaying AR data. For example, the AR apparatus may be applied to a personal computer, such as a desktop computer, a laptop, and a tablet computer, in addition to a mobile communication terminal, such as a personal digital assistant (PDA), a smart phone, and a navigation terminal.

Exemplary embodiments of the present invention are applied to a communication system in which an AR apparatus (hereinafter, referred to as “terminal”) and an AR server (hereinafter, referred to as “server”) are connected through a communication network. However, aspects of the present invention are not limited thereto; for example, aspects of the present invention may be implemented in a single hardware apparatus in which a terminal and a server are interworking with each other.

In addition, a terminal and/or a server may manage private tag information.

For example, private tag information may be managed by a terminal, and, in such case, a server may store private tag information transferred from terminals in a temporary memory 332, and the server may serve as a relay between terminals.

For example, private tag information may be managed by a server, and the server may serve to register, detect, and relay private tag information. Further, the private tag information may be managed by both the terminal and the server.

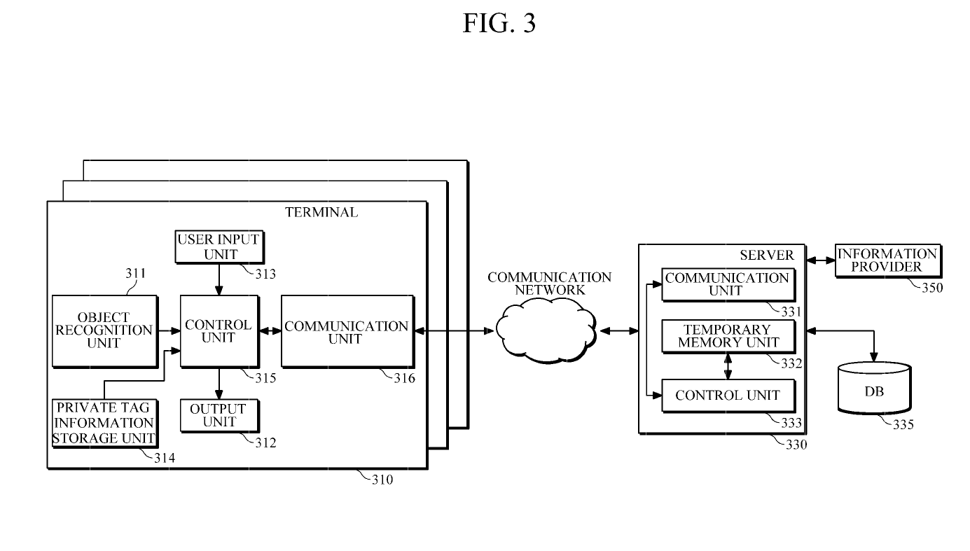

Hereinafter, an apparatus according an exemplary embodiment will be described with reference to FIG. 3. FIG. 3 is a block diagram illustrating an AR system according an exemplary embodiment.

The communication system shown in FIG. 3 includes at least one terminal 310 connected to a server 330 through a wired/wireless communication network. The server 330 provides the terminal 310 with AR data in the form of public tag information or private tag information. In addition, the server 330 is connected to an information provider 350 and a database (DB) 335 to receive the public tag information that is provided to the terminal 310 and to store the received public tag information in the DB 335.

The terminal 310 includes an object recognition unit 311, an output unit 312, a user input unit 313, a private tag information storage unit 314, a control unit 315, and a communication unit 316.

The object recognition unit 311 acquires recognition information about an object of interest among objects existing in the real world and outputs the acquired recognition information. In addition, the term “object” may represent an object, a person, a state, or a marker. In addition, the object may represent any information defined in the real world, such as data of viewing, hearing, smelling, position, climate, or speed.

Although not shown in the drawing, the object recognition unit 311 may include an object data acquisition unit and a recognition information sampling unit. The data acquisition unit may include at least one of a camera or an image sensor to acquire and output an image including an object, a microphone to acquire and output sound, an odor sensor, a global positioning system (GPS) position sensor, a terrestrial magnetism sensor, a speed sensor, and the like. The recognition information sampling unit detects a feature point to be used as recognition information from object data, which is output from the object data acquisition unit and includes at least one of image data, sound data, position data, direction data, and speed data.

The output unit 312 outputs AR data that is input from the control unit 315 of the terminal 310. The AR data may represent various types of data that are related to a recognized object. The AR data may be data obtained by combining an object with tag information or may represent only tag information. As an example, the output unit 312 may include a display unit to display visual data and a speaker to output sound data in the form of audible sound.

The user input unit 313 is an interface to receive user information, for example, a key panel, a touch screen, a microphone, and the like. In this example, the user input unit 313 receives at least one of private tag information, request information for private tag registration, and request information for AR data based on object recognition, and the user input unit 313 outputs the received at least one of the private tag information, the request information for private tag registration, and the request information for AR data to the control unit 315 of the terminal 310. In addition, the user input unit 313 may receive request information for private tag information editing or deleting and output the received request information to the control unit 315 of the terminal 310.

The private tag information storage unit 314 may store private tag information registered by a user. The private tag information storage unit 314 may be a built-in memory or a Universal Subscriber Identification Module (USIM). In addition, the private tag information storage unit 314 may include a private server connected to a terminal.

The communication unit 316 of the terminal 310 processes signals that are received from outside through a wired/wireless communication network and processes and transmits internal signals. The communication unit 316 of the terminal 310 receives and processes public tag information from the server 330 or private tag information registered by another terminal, and outputs processed public tag information or private tag information to the control unit 315 of the terminal 310. The communication unit 316 of the terminal 310 receives and processes a request information signal for tag information detection received from the control unit 315 of the terminal 310 and outputs the processed signal to the server 330.

The control unit 315 of the terminal 310 controls components of the terminal, thereby registering private tag information and generating AR data including at least one of private tag information and public tag information according to object recognition. In addition, the control unit 315 of the terminal 310 performs a private tag information managing function to register private tag information, which is requested for registering by a user, in the private tag information storage unit 314, and to detect private tag information from the private tag information storage based on object recognition. In addition, the control unit 315 of the terminal 310 may receive private tag information, which is registered by a terminal of another user and relayed to the server 330, and may store the received private tag information in the private tag information storage unit 314. In addition, the control unit 315 of the terminal 310 may perform an editing and/or deleting function on the user input information.

The server 330 includes a communication unit 331, a temporary memory unit 332, and a control unit 333.

The communication unit 331 of the server 330 processes signals that are received from the outside through a wired/wireless communication network, and processes and transmits internal signals. The temporary memory unit 332 temporarily stores private tag information that has been transferred from one terminal and is to be relayed to another terminal.

Upon reception of object recognition information through the communication unit 331 of the server 330, the control unit 333 of the server 330 detects public tag information corresponding to the received object recognition information from a DB 335 and sends the detected public tag information to the terminal 310. The control unit 333 of the server 330 stores private tag information transferred from the terminal 310 in the temporary memory 332 of the server 330 to relay the private tag information. In this case, the control unit 333 of the server 330 checks a sharing range of private tag information such that the private tag information is stored in a terminal of a user belonging to or being within the sharing range of the private tag information.

The DB 335 stores additional tag information related to an object in the form of radio frequency identification (RFID). For example, if the object is the Louvre Museum, tag information may be construction information about the Louvre Museum, a moving picture introducing its art collection, and visitor information sound. In addition, an identifier for identifying tag information may be assigned to each piece of tag information and stored. According to the first example, the DB 335 may store public tag information open to everyone.

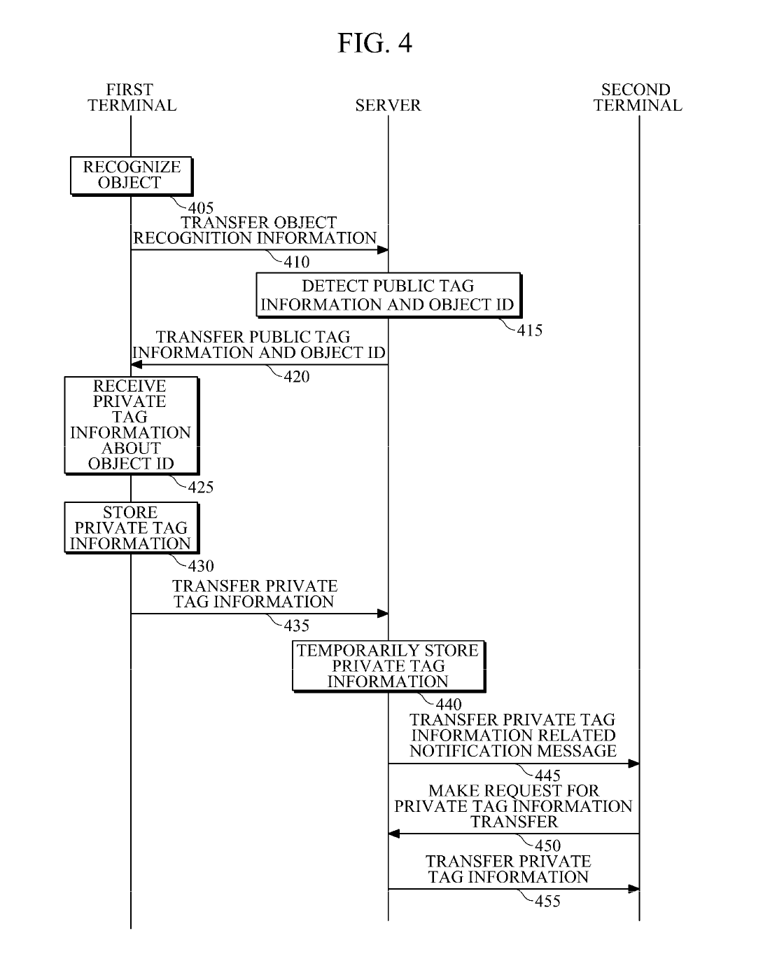

FIG. 4 is a flowchart illustrating a method of providing private tag information according to an exemplary embodiment. In FIG. 4, a first terminal represents a terminal configured to register private tag information and a second terminal represents one or more terminals belonging to or being within a sharing range of the private tag registered by the first terminal.

As shown in FIG. 4, the first terminal recognizes an object existing in the real world in operation 405, and transfers object recognition information to a server in operation 410. The server analyzes the received object recognition information in operation 415 to detect public tag information related to the object and an object identifier for identifying the object. Thereafter, the server transfers the object identifier and the object related public tag information to the first terminal in operation 420.

Upon a request for a private tag information registration by a user, the first terminal receives private tag information, which is related to the recognized object, from the user in operation 425. The private tag information may include user information and information about a sharing range of the private tag information. The first terminal stores the private tag information in operation 430. The first terminal transfers the private tag information to the server in operation 435 and requests the server to relay the private tag information such that the private tag information may be shared with another terminal user.

Here, the server may temporarily store the received private tag information in operation 440; however, aspects are not limited thereto such that the received private tag information may be stored for specific periods of time or indefinitely. For example, the time during which the private tag information is stored may be preset. The server transfers a private tag information related notification message to the second terminal in operation 445. The private tag information related notification message may include private tag information and information about a registrant.

The second terminal checks the received private tag information related notification message, if required, requests the private tag information in operation 450 and receives the private tag information in operation 455.

Although not shown, as a result of checking the received private tag information related notification message by the second terminal, if the received private tag information related notification message is determined as spam information and not required, operation 450 may be omitted. According to another example, operation 445 and operation 450 may be omitted and operation 455 may be performed on all users belonging to the sharing range of the private tag information, unless the amount of information is large enough to cause errors in communication. If private tag information input by a user is determined not to be shared, operations 435 to 450 are omitted.

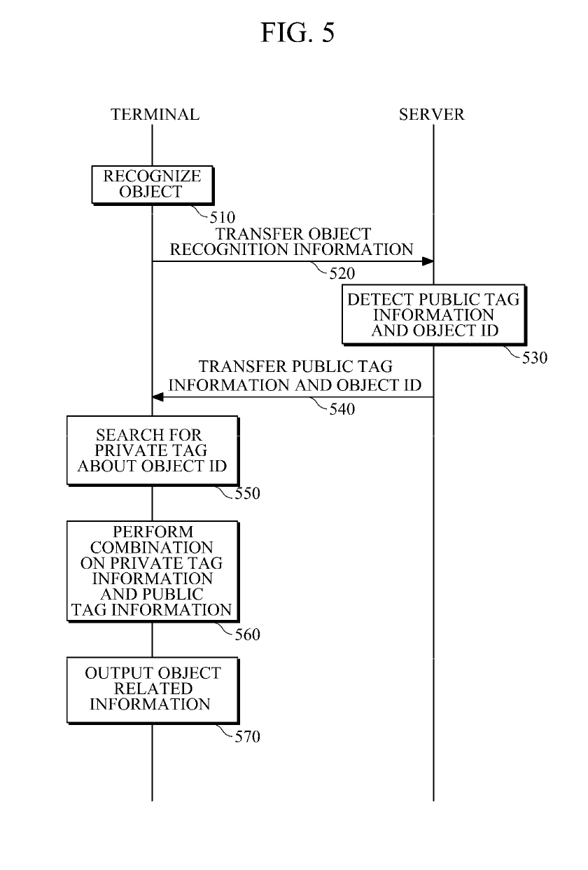

FIG. 5 illustrates a method of providing private tag information according to an exemplary embodiment.

A terminal shown in FIG. 5 includes a terminal of a registrant of private tag information and a terminal, which belongs to the sharing range of private tag information having received the private tag information. That is, the operation shown in FIG. 5 is applied to the first terminal and the second terminal of FIG. 4.

As shown in FIG. 5, the terminal recognizes an object in operation 510, and transfers obtained object recognition information to a server in operation 520.

Thereafter, the server detects public tag information corresponding to the object recognition information in operation 530. The server transfers object identifier information and the detected public tag information to the terminal in operation 540. If public tag information mapped to the object recognition information does not exist or is not detected in operation 530, the server may transfer object identifier information without public tag information in operation 540.

The terminal searches for private tag information mapped to the received object identifier in operation 550. The terminal combines the detected private tag information and the public tag information with an object of the real world in operation 560 and outputs object related information in operation 570.

If private tag information is not found in operation 550, only public tag information is combined with an object of the real world in operation 560. In addition, if the public tag information has not been transferred in operation 540, only private tag information is combined with an object of the real world in operation 560.

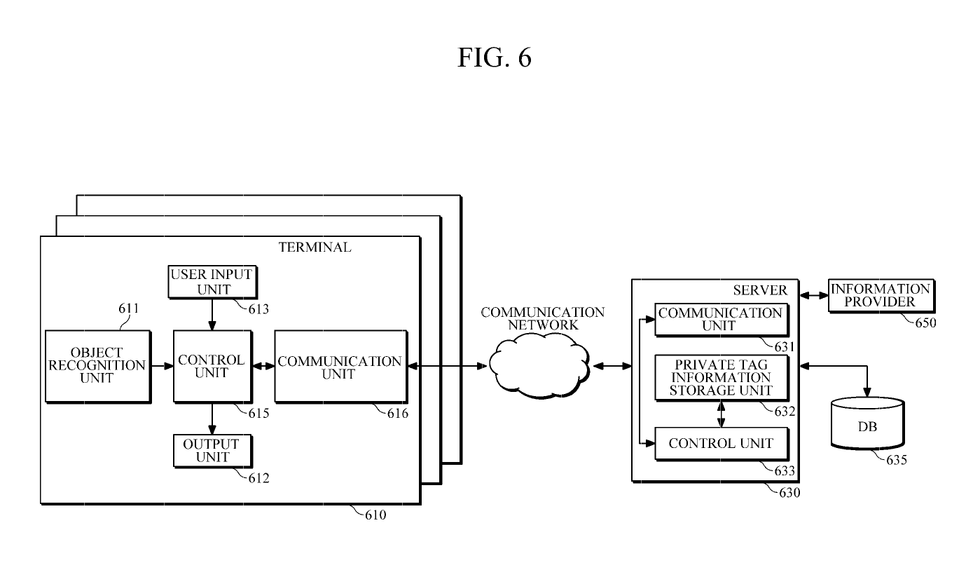

Hereinafter, an apparatus according to an exemplary embodiment will be described with reference to FIG. 6.

FIG. 6 is a block diagram illustrating an AR system according to an exemplary embodiment. Details of parts identical to those of FIG. 3 will be omitted in order to avoid redundancy and the details of FIG. 6 will be described based on differences from FIG. 3. An object recognition unit 611, an output unit 612, a user input unit 613, and a communication unit 616 of a terminal 610 shown in FIG. 6 are similar, respectively, to the object recognition unit 311, the output unit 312, the user input unit 313, and the communication unit 316 of the terminal 310 shown in FIG. 3 and will not be further described. In addition, a communication unit 631 of a server 630, an information provider 650, and a DB 635 shown in FIG. 6 are similar, respectively, to the communication unit 331 of the server 330, the information provider 350, and the DB 335 shown in FIG. 3 and will not be further described.

Unlike FIG. 3, the server 630 further includes a private tag information storage unit 632 instead of the temporary storage unit 332, and a terminal 610 does not include the private tag information storage 314 as shown in FIG. 3.

Accordingly, a control unit 633 of the server 630 stores private tag information transferred from the terminal 610 in the private tag information storage unit 632 to register, detect, edit, and/or delete the private tag information upon a request by the terminal 610. Similarly, a control unit 615 of the terminal 610 need not store the private tag information in the terminal 610; however, aspects are not limited thereto such that the control unit 615 of the terminal 610 may store the private tag information similarly to as described above with respect to FIG. 3. Further, each of the terminal 610 and the server 630 may store the private tag information for a specific amount of time.

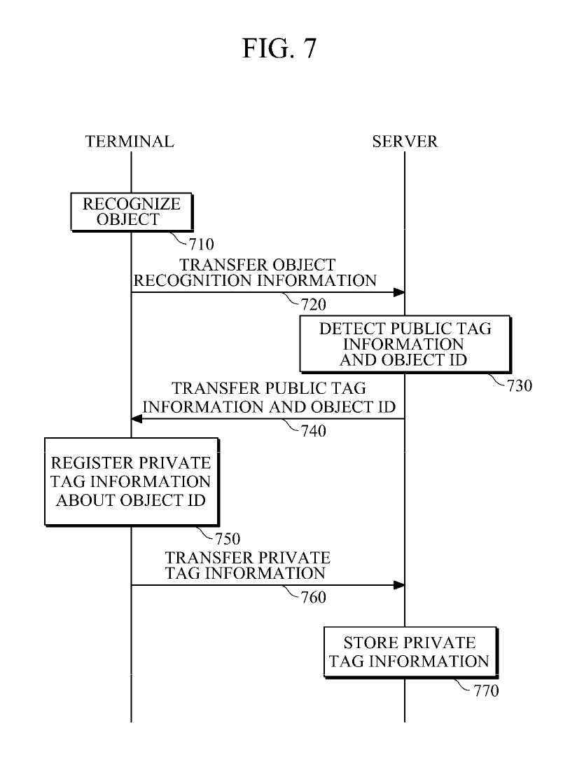

FIG. 7 illustrates a method of providing private tag information according to an exemplary embodiment. As shown in FIG. 7, the terminal recognizes an object existing in the real world in operation 710 and transfers object recognition information to the server in operation 720.

The server analyzes the received object recognition information to detect an object identifier and public tag information corresponding to the object identifier in operation 730, and transfers the detected object identifier and public tag information to the terminal in operation 740. If public tag information corresponding to the object identifier is not detected in operation 730, the server may transfer the object identifier to the terminal.

Upon a request for private tag information registration by a user, the terminal receives private tag information mapped to the object identifier from the user in operation 750. The private tag information may include content information input by a user and sharing range information. The terminal transfers the private tag information to the server in operation 760. The server stores the private tag information in operation 770. The server may store the private tag information aside from or separately from the public tag information.

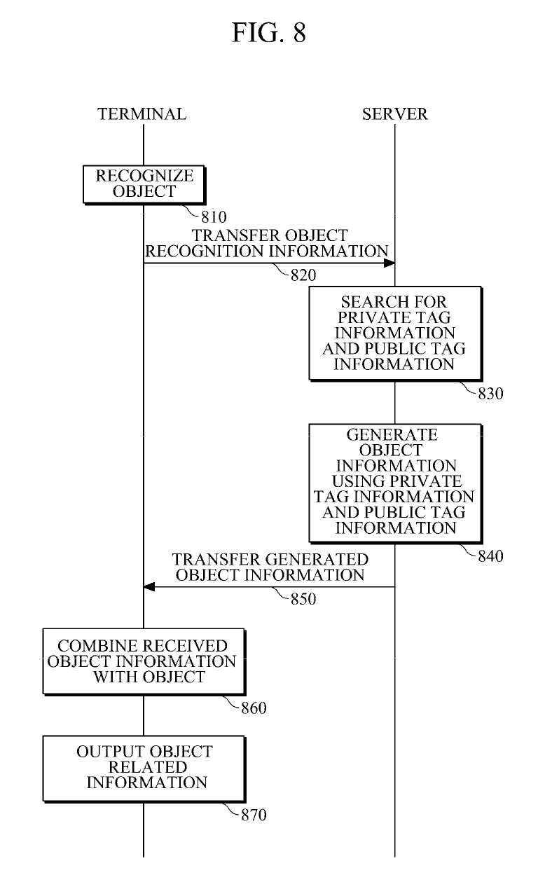

FIG. 8 illustrates a method according to an exemplary embodiment.

A terminal shown in FIG. 8 includes a terminal of a registrant of private tag information and a terminal belonging to the sharing range of private tag information having received the private tag information.

As shown in FIG. 8, the terminal recognizes an object in operation 810, and the terminal transfers obtained object recognition information to a server in operation 820.

Thereafter, the server detects public tag information and private tag information corresponding to the object recognition information in operation 830. In this case, at least one of pubic tag information and private tag information may be detected. Even if private tag information is detected, if the terminal does not belong to the sharing range of the private tag information, the private tag information may not be provided to the terminal. The server generates object information using the detected private tag information and the public tag information in operation 840 and transmits to the terminal the generated object information together with an object identifier in operation 850.

The terminal combines at least one of the received private tag information and the received public tag information with the object in operation 860 and outputs object related information obtained by the combining in operation 870.

The disclosure can also be embodied as computer readable codes on a computer readable recording medium. The computer readable recording medium may be any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so that the computer readable code is stored and executed in a distributed fashion.

Also, functional programs, codes, and code segments for accomplishing the present invention can be easily construed by programmers skilled in the art to which the present invention pertains. A number of exemplary embodiments have been described above. It will be apparent to those skilled in the art that various modifications and variation can be made in the present invention without departing from the spirit or scope of the invention. For example, suitable results may be achieved if the described techniques are performed in a different order and/or if components in a described system, architecture, device, or circuit are combined in a different manner and/or replaced or supplemented by other components or their equivalents. Thus, it is intended that the present invention cover the modifications and variations of this invention provided they come within the scope of the appended claims and their equivalents.

What is claimed is:

1. A method for providing private tag information by a terminal accessible to a server, the method comprising:
recognizing an object by the terminal;
detecting private tag information corresponding to the recognized object, the private tag information comprising a sharing range; and
outputting the detected private tag information in the terminal.

2. The method of claim 1, further comprising:
transferring object recognition information about the recognized object from the terminal to the server;
receiving public tag information corresponding to the transferred object recognition information in the terminal from the server; and
outputting the received public tag information in the terminal.

3. A method for providing private tag information by a terminal accessible to a server, the method comprising:
receiving, in the terminal, user information related to an object; and
storing the received user information as private tag information related to the object, the private tag information comprising a sharing range.

4. The method of claim 3, wherein the receiving of the user information related to the object comprises receiving the sharing range information about the private tag information.

5. The method of claim 4, further comprising transmitting to the server a request for relay of the private tag information such that the private tag information is transmitted to the server, the transmitted private tag information being shareable according to the sharing range.

6. The method of claim 3, further comprising receiving, in the terminal from the server, private tag information registered by another terminal, and storing the received private tag information.

7. A method for providing private tag information by a server that is accessible to two or more terminals, the method comprising:
receiving private tag information representing user information, which is related to an object, and information about a sharing range of the private tag information from a first terminal; and
transferring the received private tag information to a second terminal within the sharing range of the received private tag information.

8. A terminal to provide private tag information, the terminal comprising:
an object recognition unit to output object recognition information indicating that an object is recognized;
an output unit to output private tag information;
a storage unit to store one or more pieces of private tag information; and
a control unit to detect private tag information, which corresponds to the object recognition information output from the object recognition unit and comprises a sharing range, from the storage unit, and to output the detected private tag information through the output unit.

9. The terminal of claim 8, further comprising:
a communication unit to process information, which is transmitted to and/or received from a server,
wherein the control unit transfers the object recognition information to the server through the communication unit, receives public tag information corresponding to the object recognition information from the server, and outputs the received public tag information through the output unit.

10. The terminal of claim 8, further comprising a manipulation unit to receive user information related to the object,
wherein the control unit stores the received user information in the storage unit as private tag information related to the object.

11. The terminal of claim 10, wherein the control unit receives sharing range information about the sharing range of the private tag information.

12. The terminal of claim 10, wherein the control unit transmits to the server a request for relay of the private tag information such that the private tag information is transferred to the server through the communication unit and is shareable to another terminal.

13. The terminal of claim 10, wherein the control unit receives private tag information registered by another terminal from the server and stores the received private tag information in the storage unit.

14. A server to provide private tag information, the server comprising:
a communication unit to process information, which is transmitted to and/or received from one or more terminals,
a memory unit to temporarily store private tag information; and
a control unit to receive, from a first terminal through the communication unit, private tag information comprising user information, which is related to an object, and sharing range information about a sharing range of the private tag information, to store the received private tag information in the memory unit, and to transfer the received private tag information to a second terminal within the sharing range of the received private tag information.

15. A method for providing private tag information by a terminal accessible to a server, the method comprising:
recognizing an object;
transferring object recognition information about the recognized object to the server;
receiving private tag information comprising a sharing range from the server; and
outputting the received private tag information.

16. The method of claim 15, further comprising:
receiving public tag information corresponding to the received object from the server; and
outputting the received public tag information.

17. A method for providing private tag information by a server which is accessible to one or more terminals, the method comprising:
storing the private tag information, the private tag information being received from the one or more terminals and comprising a sharing range and information related to an object;
receiving object recognition information from a first terminal of the one or more terminals;
detecting private tag information corresponding to the object recognition information; and
transferring the detected private tag information to the first terminal if the first terminal is within the sharing range of the detected private tag information.

18. The method of claim 17, further comprising:
detecting public tag information corresponding to the object recognition information; and
transferring the detected public tag information to the first terminal.

19. A method for providing private tag information by a terminal accessible to a server, the method comprising:
receiving user information related to an object; and
transmitting to the server the received user information and requesting for registering of the received user information as private tag information, the private tag information being related to the object and comprising a sharing range.

20. A method for providing private tag information by a server accessible to one or more terminals, the method comprising:
receiving private tag information from the one or more terminals; and
setting a sharing range of the received private tag information and registering the received private tag information according to the sharing range.

21. A terminal to provide private tag information, the terminal comprising:
an object recognition unit to recognize an object and to output object recognition information about the recognized object;
an output unit to output tag information;
a communication unit to process information transmitted to and/or received from a server; and
a control unit to transfer the object recognition information output from the object recognition unit to the server through the communication unit, to receive private tag information comprising a sharing range from the server, and to output the received private tag information through the output unit.

22. The terminal of claim 21, wherein the control unit receives from the server public tag information corresponding to the recognized object and outputs the received public tag information.

23. The terminal of claim 21, further comprising:
a manipulation unit to receive user information related to the object,
wherein the control unit transmits to the server the received user information and requests for registration of the received user information as private tag information, is the private tag information being related to the object and comprising a sharing range.

24. A server to provide private tag information, the server comprising:
a communication unit to access one or more terminals to process information transmitted to and/or received from the one or more terminals;
a storage unit to store one or more pieces of tag information;
a control unit to, in response to receipt of object recognition information from a first terminal of the one or more terminals, detect private tag information corresponding to the object recognition information among the one or more pieces of tag information in the storage unit, and to transfer the detected private tag information to the first terminal if the first terminal is within a sharing range of the detected private tag information.

25. The server of claim 24, wherein the control unit detects public tag information corresponding to the object recognition information received from the first terminal and transfers the detected public tag information to the first terminal.

26. The server of claim 24, wherein the control unit receives private tag information from the first terminal, sets a sharing range of the received private tag information, and registers the private tag information according to the sharing range.
